(19) United States
(12) Patent Application Publication
(10) Pub. No.: US 2024/0201751 A1
(43) Pub. Date: Jun. 20, 2024

(54) DOUBLE-SHAFT HINGE IMPLEMENTED WITH FLEXIBLE DISPLAY

(71) Applicant: Sinher Technology Inc., New Taipei (TW)

(72) Inventors: Feng-Yu CHUNG, New Taipei (TW); Chih-Huang PENG, New Taipei (TW); Nan-Hai LAI, New Taipei (TW)

(21) Appl. No.: 18/083,108

(22) Filed: Dec. 16, 2022

(51) Int. Cl. G06F 1/16

(52) U.S. Cl. CPC G06F 1/1681; G06F 1/1652; E05D 3/12

(57) ABSTRACT

The invention provides a double-shaft hinge implemented with a flexible display. The double-shaft hinge includes a first shaft, a second shaft parallel to the first shaft and a shaft mounting base. The first shaft is provided with a first wheel. A first notch is formed in a periphery of the first wheel. The second shaft is provided with a second wheel. A second notch is formed in a periphery of the second wheel. Two supporting blocks are arranged at one side of the shaft mounting base facing the first wheel and the second wheel. An equal armed lever is mounted on the two supporting blocks. The equal armed lever takes the two supporting blocks as moving fulcrums. The equal armed lever selectively falls into the first notch or the second notch to switch between rotating the first shaft and rotating the second shaft.

### FIELD OF THE INVENTION

The invention relates to a double-shaft hinge implemented with a flexible display, in particular to a double-shaft hinge switching the rotation of two shafts through an equal armed lever.

### BACKGROUND OF THE INVENTION

There are conventional double-shaft hinges comprising a movable switching piece to switch the shaft that is rotating, such as Taiwan Patent No. TW M584450, TW 1763516, TW M625917, TW M625897 and TW M581358. During implementation of such a double-shaft hinge, the movable switch piece temporarily restricts the rotation of one of the two shafts; and when the other of the two shafts moves to allow the movable switching piece to have displacement, one of the two shafts which is originally restricted from rotating will return to a rotatable state, while one of the two shafts which is originally rotatable will be restricted from rotating by the movable switching piece, so as to achieve the objective of switching shaft rotation.

However, a movement space of the movable switching piece is not conducive to decrease the volume of the above-mentioned double-shaft hinge, thereby affecting the adoption of an implementation object. In addition, the above-mentioned double-shaft hinge further has a risk of misoperation of the movable switching piece.

### SUMMARY OF THE INVENTION

A major objective of the invention is to solve a problem that a movement space of a movable switching piece is not conducive to decrease the whole volume of a conventional double-shaft hinge.

Another major objective of the invention is to solve a problem that the movable switching piece of the conventional double-shaft hinge has a risk of misoperation.

To achieve the objectives, the invention provides a double-shaft hinge, implemented with a flexible display, including a first shaft, a second shaft parallel to the first shaft, and a shaft mounting base. The first shaft includes a first wheel. A first notch is formed in a periphery of the first wheel. The second shaft includes a second wheel. A second notch is formed in a periphery of the second wheel. The shaft mounting base includes two mounting holes provided for installing the first shaft and the second shaft therein respectively. Two supporting blocks are arranged in parallel at a surface of the shaft mounting base facing the first wheel and the second wheel and are located between the two mounting holes. An equal armed lever is mounted on the two supporting blocks. The two supporting blocks act as fulcrum of the equal armed lever. The equal armed lever includes a first end pushed by the periphery of the first wheel, and a second end opposite to the first end and pushed by the periphery of the second wheel. When the first end is engaged with the first notch, the first shaft is restricted from rotating. When the second end is engaged with the second notch, the second shaft is restricted from rotating. The first end and the second end do not engage with both of the first notch and the second notch at the same time. Only one of the first end and the second end is engaged with the first notch or the second notch at a time.

In one embodiment, the shaft mounting base includes a mounting groove accommodating the equal armed lever, and the two supporting blocks are respectively formed on two opposite groove walls of the mounting groove.

In one embodiment, the shaft mounting base includes a limiting block arranged on another surface of the shaft mounting base opposite to the first wheel and the second wheel, the limiting block is located between the two mounting holes, the first shaft includes a third wheel, a rotatable angle of the first shaft is restricted along a rotating trajectory of the third wheel limited by the limiting block, the second shaft includes a fourth wheel, and an other rotatable angle of the second shaft is restricted along a rotat-ing trajectory of the fourth wheel limited by the limiting block.

In one embodiment, the limiting block includes a first stopper plane ar-ranged at a side of the limiting block facing the third wheel and capable of butting against the third wheel, a first inclined plane connected with the first stopper plane, a second stopper plane arranged at a side of the limiting block facing the fourth wheel and capable of butting against the fourth wheel, a second inclined plane connected with the second stopper plane, and two connecting surfaces parallel to two side edges of the shaft mounting base, the first stopper plane is connected with one of the two connecting surfaces, and the second stopper plane is connected with an-other one of the two connecting surfaces.

In one embodiment, the third wheel includes a first track and a first butting plane provided at an end of the first track and capable of butting against the first stopper plane, the fourth wheel includes a second track and a second butting plane provided at an end of the second track and capable of butting against the second stopper plane.

In one embodiment, the first wheel includes a first plane arranged at a face of the first wheel facing the shaft mounting base and connected with the first notch, and the second wheel includes a second plane arranged at a face of the second wheel facing the shaft mounting base and connected with the second notch.

In one embodiment, the double-shaft hinge includes a first torque generating component arranged on the first shaft and a second torque generating component arranged on the second shaft.

In one embodiment, the double-shaft hinge includes an auxiliary support plate being spaced from the shaft mounting base and facing the equal armed lever, and the auxiliary support plate includes two through holes provided for the first shaft and the second shaft to penetrate therethrough.

In one embodiment, the equal armed lever includes a body formed with the first end and the second end, two assembling columns extending from the body and assembled with the two supporting blocks respectively, and an auxiliary positioning block formed on the body, and the auxiliary positioning block is arranged between the two assembling columns.

In one embodiment, the body is not a flat straight piece.

Through the above-mentioned implementation of the invention, compared with the conventional technique, the invention has the following characteristics: the equal armed lever of the invention does not move during actuation of the double-shaft hinge, which changes the embodiment of a movable switching piece commonly adopted in the conventional double-shaft hinge. The structure of the invention does not need a space for the movable switching piece to slide, and the structure is capable of reducing unintentional switching, which is a great improvement for the conventional double-shaft hinge designed compactly.

### BRIEF DESCRIPTION OF THE DRAWINGS

FIG. 1 is a schematic diagram of an embodiment of a double-shaft hinge provided by the invention.

FIG. 2 is an exploded schematic diagram (I) of the embodiment of the double-shaft hinge provided by the invention.

FIG. 3 is an exploded schematic diagram (II) of the embodiment of the double-shaft hinge provided by the invention.

FIG. 4 is an sectional schematic diagram of the embodiment of the double-shaft hinge while a first shaft is rotatable according to the invention.

FIG. 5 is a schematic diagram of a line A-A in FIG. 4 of the in invention.

FIG. 6 is a schematic diagram of a line B-B in FIG. 4 of the invention.

FIG. 7 is a sectional schematic diagram of the embodiment of the double-shaft hinge while a second shaft is rotatable according to the invention.

FIG. 8 is a schematic diagram of a line C-C in FIG. 7 of the invention.

FIG. 9 is a schematic diagram of a line D-D in FIG. 7 of the invention.

### DETAILED DESCRIPTION OF THE PREFERRED EMBODIMENTS

The detailed description and the technical content of the invention are described in cooperation with the drawings as follows now:

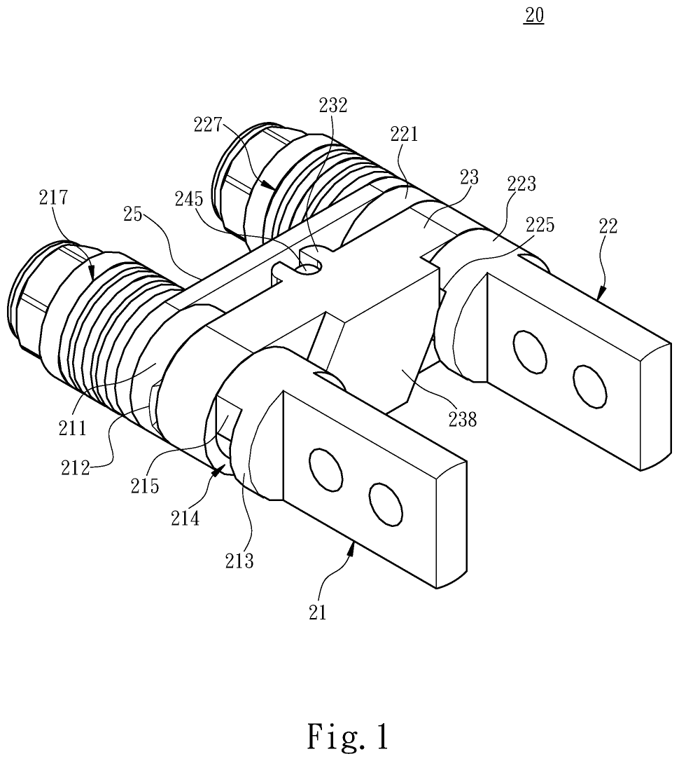

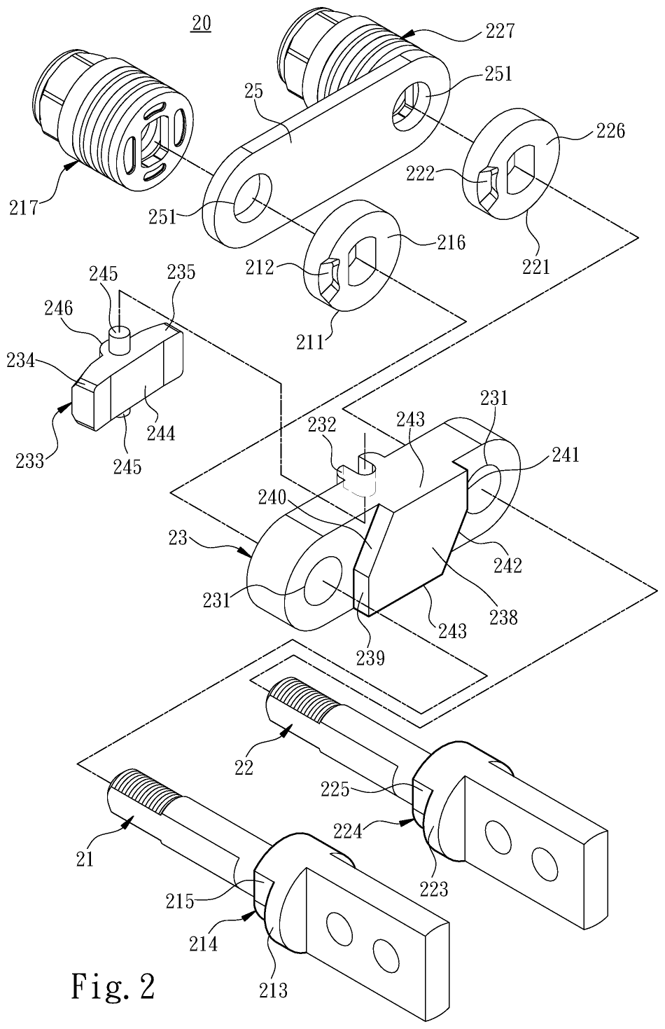

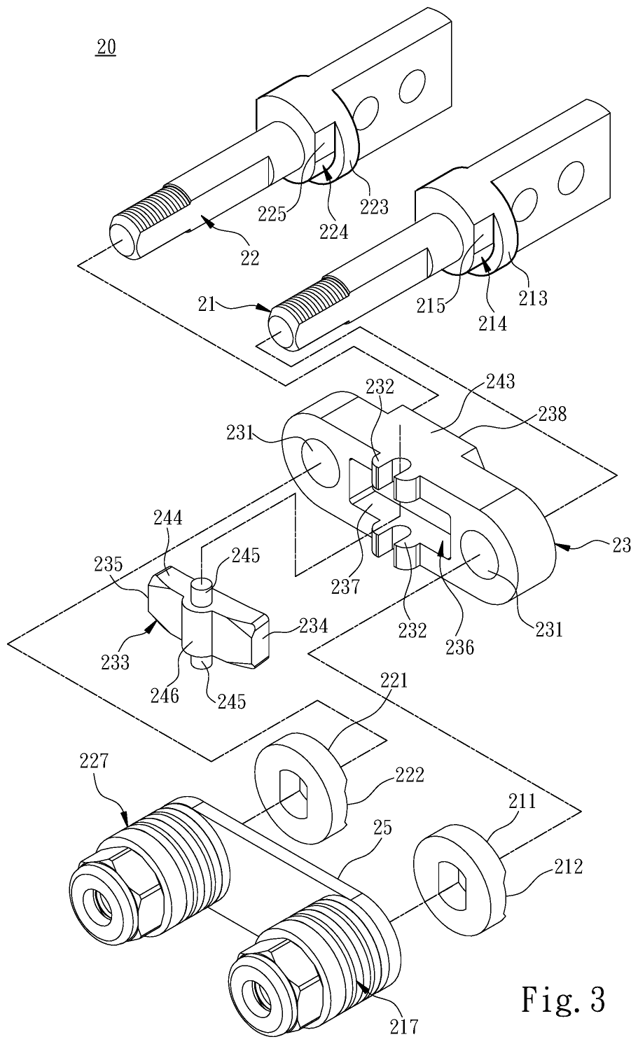

Referring to FIG. 1, FIG. 2, and FIG. 3, the invention provides a double-shaft hinge 20 implemented with a flexible display. The double-shaft hinge 20 includes a first shaft 21, a second shaft 22 and a shaft mounting base 23. The first shaft 21 includes a first wheel 211. A first notch 212 is formed in a periphery of the first wheel 211. The second shaft 22 includes a second wheel 221. A second notch 222 is formed in a periphery of the second wheel 221. The shaft mounting base 23 includes two mounting holes 231 provided for installing the first shaft 21 and the second shaft 22 therein respectively. Two supporting blocks 232 are arranged in parallel at a surface of the shaft mounting base 23 facing the first wheel 211 and the second wheel 221 and located between the two mounting holes 231. An equal armed lever 233 mounted on the two supporting blocks 232.

In addition, the two supporting blocks 232 act as fulcrum of the equal armed lever 233 to swing. The equal armed lever 233 includes a first end 234 and a second end 235 opposite to the first end 234. After the equal armed lever 233 is assembled in the double-shaft hinge 20, the first end 234 and the second end 235 may be in contact with the first wheel 211 and the second wheel 221 respectively, i.e., the first end 234 is pushed by periphery of the first wheel 211 and the second end 235 is pushed by periphery of the second wheel 221. Further, when the first end 234 is engaged with the first notch 212, the first shaft 21 is restricted from rotating. When the second end 235 is engaged with the second notch 222, the second shaft 22 is restricted from rotating, so that the first end 234 and the second end 235 do not engage with both of the first notch 212 and the second notch 222 at the same time, and only one of the first end 234 and the second end 235 is engaged with the first notch 212 or the second notch 222 at a time.

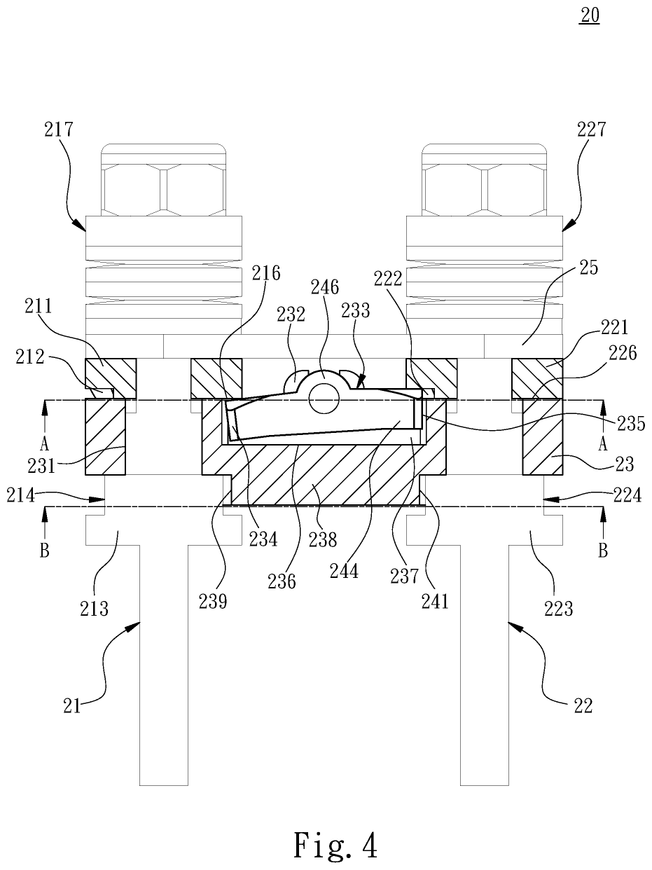

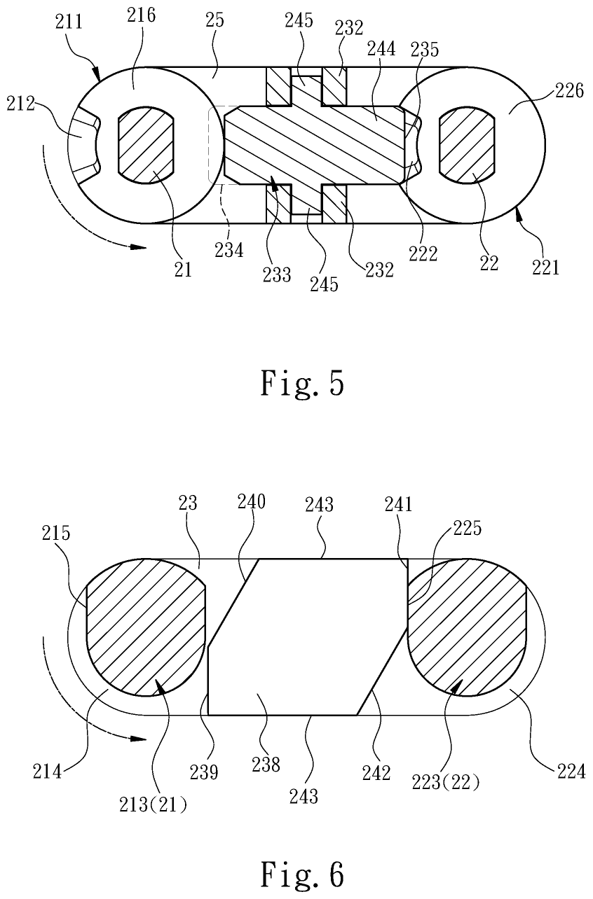

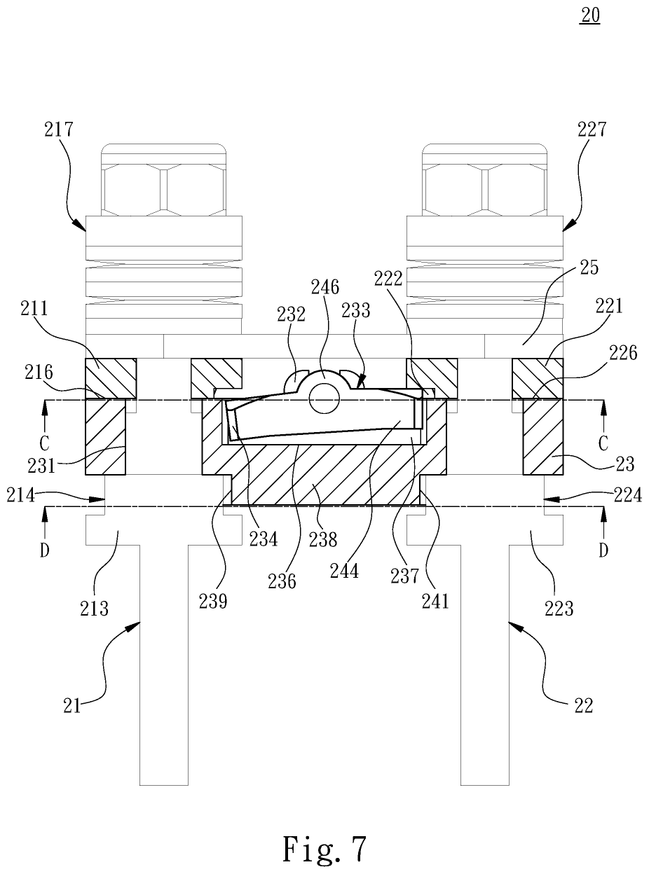

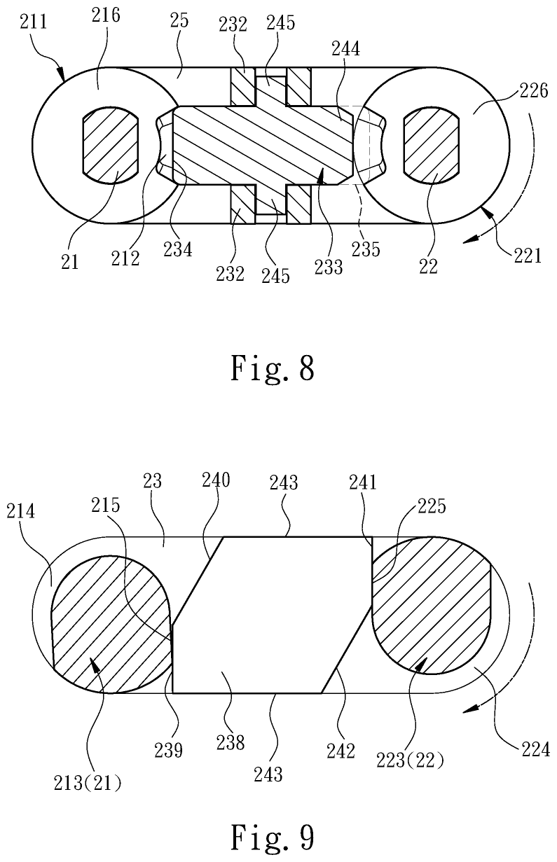

Referring to FIG. 4, FIG. 5, and FIG. 6, before the double-shaft hinge 20 is being operated, it is assumed that the first end 234 of the equal armed lever 233 is in contact with a surface of the first wheel 211 where the first notch 212 is not formed, and the second end 235 is engaged with the second notch 222. At the beginning of operation, the second shaft 22 is unable to rotate because the second end 235 of the equal armed lever 233 is engaged with the second notch 222, so that only the first shaft 21 is capable of rotating when the double-shaft hinge 20 rotates initially, until the first shaft 21 rotated a certain angle, the first notch 212 faces the first end 234, as shown in FIG. 7, FIG. 8, and FIG. 9. At this time, state of the equal armed lever 233 is not restricted. Next, when force is applied to operate the double-shaft hinge 20, the second wheel 221 pushes the equal armed lever 233, so that posture of the equal armed lever 233 is changed, the second end 235 of the equal armed lever 233 disengage from the second notch 222 and is in contact with a surface of the second wheel 221 where the second notch 222 is not formed, thereby allowing the second shaft 22 to rotate. At the same time, the first end 234 of the equal armed lever 233 is engaged with the first notch 212 to restrict the first shaft 21 from rotating. In this way, effect of switching between rotation of the first shaft 21 and rotation of the second shaft 22 is achieved; and the subsequent rotation of the double-shaft hinge 20 is generated by the second shaft 22.

In addition, there is no displacement of the equal armed lever 233 of the invention during operation of the double-shaft hinge 20, which changes the implementation scheme of a movable switching piece commonly adopted in the conventional double-shaft hinge. The structure of the invention does not need a space for the movable switching piece to slide and is capable of reducing erroneous switching, which is a great improvement for the conventional double-shaft hinge designed compactly.

Referring to FIG. 3 and FIG. 4, the shaft mounting base 23 includes a mounting groove 236 for accommodating the equal armed lever 233, and the two supporting blocks 232 are respectively formed on two opposite groove walls 237 of the mounting groove 236. In one embodiment, the two supporting blocks 232 are both claw-shaped, to be assembled with connecting parts of the equal armed lever 233.

Referring to FIG. 2, FIG. 6 and FIG. 9, in one embodiment, the shaft mounting base 23 includes a limiting block 238 arranged on another surface of the shaft mounting base 23 opposite to the first wheel 211 and the second wheel 221. The limiting block 238 is located between the two mounting holes 231. In another aspect, the first shaft 21 includes a third wheel 213. The third wheel 213 and the first wheel 211 are respectively located on two opposite sides of the shaft mounting base 23 after assembly. In structural design, at least one of the first wheel 211 and the third wheel 213 is not integrally formed with the first shaft 21. In addition, a rotatable angle of the first shaft 21 is restricted along a rotating trajectory of the third wheel 213 limited by the limiting block 238. Furthermore, the second shaft 22 includes a fourth wheel 223. The fourth wheel 223 and the second wheel 221 are respectively located on two opposite sides of the shaft mounting base 23 after assembly. The structural design of the second shaft 22 is the same as that of the first shaft 21; and at least one of the second wheel 221 and the fourth wheel 223 is not integrally formed with the second shaft 22. Moreover, another rotatable angle of the second shaft 22 is restricted along a rotating trajectory of the fourth wheel 223 limited by the limiting block 238. Specifically, the third wheel 213 and the fourth wheel 223 are not always interfered by the limiting block 238. The third wheel 213 still allows the first shaft 21 to rotate within the rotatable angle range. Explicitly, during the rotation of the first shaft 21, once the third wheel 213 is unable to rotate due to the interference of the limiting block 238, the first shaft 21 will be restricted from continuing to rotate. In addition, the fourth wheel 223 also allows the second shaft 22 to rotate within another rotatable angle. Further, a time point when the third wheel 213 is interfered by the limiting block 238 is different from a time point when the fourth wheel 223 is interfered by the limiting block 238.

In addition, referring to FIG. 2, FIG. 6 and FIG. 9, in one embodiment, the limiting block 238 includes a first stopper plane 239 arranged at a side of the limiting block 238 facing the third wheel 213 and capable of butting against the third wheel 213, a first inclined plane 240 connected with the first stopper plane 239, a second stopper plane 241 arranged at an other side of the limiting block 238 facing the fourth wheel 223 and capable of butting against the fourth wheel 223, a second inclined plane 242 connected with the second stopper plane 241, and two connecting surfaces 243 parallel to two side edges of the shaft mounting base 23. The first stopper plane 239 is connected with one of the two connecting surfaces 243, and the second stopper plane 241 is connected with an other one of the two connecting surfaces 243; i.e., the first stopper plane 239 and the second stopper plane 241 are diagonally arranged on the limiting block 238. Furthermore, the first stopper plane 239 and the second stopper plane 241 are arranged in parallel. The third wheel 213 includes a first track 214. Part of the limiting block 238 is located in the first track 214. The third wheel 213 includes a first butting plane 215 provided at a tail end of the first track 214. The first butting plane 215 is capable of butting against the first stopper plane 239. In one embodiment, a concaved area of the third wheel 213 is defined as the first track 214, and the concaved area is located at one side of the third wheel 213 facing the shaft mounting base 23, so that the surface of the shaft mounting base 23 is provided as a wall of the first track 214. Moreover, the fourth wheel 223 includes a second track 224. Part of the limiting block 238 is located in the second track 224. The fourth wheel 223 includes a second butting plane 225 provided at a tail end of the second track 224. The second butting plane 225 is capable of butting against the second stopper plane 241, a concaved area of the fourth wheel 223 is defined as the second track 224, the concaved area of the fourth wheel 223 is located at one side of the fourth wheel 223 facing the shaft mounting base 23, so that the surface of the shaft mounting base 23 is provided as a side wall of the second track 224.

Referring to FIG. 2 and FIG. 3, in one embodiment, the first wheel 211 includes a first plane 216, arranged at a face of the first wheel 211 facing the shaft mounting base 23 and connected with the first notch 212; and the second wheel 221 includes a second plane 226, arranged at a face of the second wheel 221 facing the shaft mounting base 23 and connected with the second notch 222. As mentioned above, the side of the first wheel 211 facing the shaft mounting base 23 is a plane (i.e., the first plane 216) except for the part where the first notch 212 is formed. The side of the second wheel 221 facing the shaft mounting base 23 is a plane (i.e., the second plane 226) except for the part where the second notch 222 is formed.

Referring to FIG. 1, FIG. 2, and FIG. 3, in one embodiment, the double-shaft hinge 20 includes a first torque generating component 217 arranged on the first shaft 21 and a second torque generating component 227 arranged on the second shaft 22. The composition of the first torque generating component 217 and the second torque generating component 227 are implemented as the conventional double-shaft hinge field according to the design. In addition, the first torque generating component 217 and the second torque generating component 227 respectively provide the torque required by the rotation of the first shaft 21 and the second shaft 22.

Referring to FIG. 2 and FIG. 3, in one embodiment, the double-shaft hinge 20 includes an auxiliary support plate 25 being spaced from the shaft mounting base 23 and facing the equal armed lever 233. The auxiliary support plate 25 includes two through holes 251 provided for the first shaft 21 and the second shaft 22 to penetrate therethrough. The auxiliary support plate 24 and the shaft mounting base 23 stabilize the movement of the first shaft 21 and the second shaft 22, and the auxiliary support plate 24 is regarded as a shield for the equal armed lever 233, thereby avoiding other objects to mistakenly interfere with the movement of the equal armed lever 233.

Referring to FIG. 3, in one embodiment, the equal armed lever 233 includes a body 244 formed with the first end 234 and the second end 235, two assembling columns 245 extending from the body 244 and assembled with the two supporting blocks 232 respectively, and an auxiliary positioning block 246 formed on the body 244, and the auxiliary positioning block 246 is arranged between the two assembling columns 245. After the equal armed lever 233 is assembled, the auxiliary positioning block 246 is sandwiched between the two supporting blocks 232, to prevent the equal armed lever 233 from failing to move correctly due to wrong deviation. Referring to FIG. 4 and FIG. 7, in one embodiment, the body 244 is not a flat straight piece. Further, the first end 234 and the second end 235 of the body 244 are slightly bent, so that the first end 234 and the second end 235 do not protrude excessively when the body 244 is inclined, which is beneficial to reducing a working space of the equal armed lever 233. In addition, the slight bending of the first end 234 and the second end 235 reduces the possibility of erroneous collision with the first wheel 211 and the second wheel 221.

What is claimed is:

1. A double-shaft hinge, implemented with a flexible display, comprising:
a first shaft, comprising a first wheel, wherein a first notch is formed in a periphery of the first wheel;
a second shaft, parallel to the first shaft and comprising a second wheel, wherein a second notch is formed in a periphery of the second wheel; and
a shaft mounting base, comprising two mounting holes provided for installing the first shaft and the second shaft therein respectively, two supporting blocks arranged in parallel at a surface of the shaft mounting base facing the first wheel and the second wheel and located between the two mounting holes, and an equal armed lever mounted on the two supporting blocks, wherein the two supporting blocks act as fulcrum of the equal armed lever, the equal armed lever comprises a first end pushed by the periphery of the first wheel, and a second end opposite to the first end and pushed by the periphery of the second wheel, when the first end is engaged with the first notch, the first shaft is restricted from rotating, when the second end is engaged with the second notch, the second shaft is restricted from rotating, the first end and the second end do not engage with both of the first notch and the second notch at the same time, and only one of the first end and the second end is engaged with the first notch or the second notch at a time.

2. The double-shaft hinge according to claim 1, wherein the shaft mounting base comprises a mounting groove accommodating the equal armed lever, and the two supporting blocks are respectively formed on two opposite groove walls of the mounting groove.

3. The double-shaft hinge according to claim 1, wherein the shaft mounting base comprises a limiting block arranged on another surface of the shaft mounting base opposite to the first wheel and the second wheel, the limiting block is located between the two mounting holes, the first shaft comprises a third wheel, a rotatable angle of the first shaft is restricted along a rotating trajectory of the third wheel limited by the limiting block, the second shaft comprises a fourth wheel, and an other rotatable angle of the second shaft is restricted along a rotating trajectory of the fourth wheel limited by the limiting block.

4. The double-shaft hinge according to claim 3, wherein the limiting block comprises a first stopper plane arranged at a side of the limiting block facing the third wheel and capable of butting against the third wheel, a first inclined plane connected with the first stopper plane, a second stopper plane arranged at a side of the limiting block facing the fourth wheel and capable of butting against the fourth wheel, a second inclined plane connected with the second stopper plane, and two connecting surfaces parallel to two side edges of the shaft mounting base, the first stopper plane is connected with one of the two connecting surfaces, and the second stopper plane is connected with another one of the two connecting surfaces.

5. The double-shaft hinge according to claim 4, wherein the third wheel comprises a first track and a first butting plane provided at an end of the first track and capable of butting against the first stopper plane, and the fourth wheel comprises a second track and a second butting plane provided at an end of the second track and capable of butting against the second stopper plane.

6. The double-shaft hinge according to claim 5, wherein the first wheel comprises a first plane arranged at a face of the first wheel facing the shaft mounting base and connected with the first notch, and the second wheel comprises a second plane arranged at a face of the second wheel facing the shaft mounting base and connected with the second notch.

7. The double-shaft hinge according to claim 6, wherein the double-shaft hinge comprises a first torque generating component arranged on the first shaft and a second torque generating component arranged on the second shaft.

8. The double-shaft hinge according to claim 7, wherein the double-shaft hinge comprises an auxiliary support plate being spaced from the shaft mounting base and facing the equal armed lever, and the auxiliary support plate comprises two through holes provided for the first shaft and the second shaft to penetrate therethrough.

9. The double-shaft hinge according to claim 8, wherein the equal armed lever comprises a body formed with the first end and the second end, two assembling columns extending from the body and assembled with the two supporting blocks respectively, and an auxiliary positioning block formed on the body, and the auxiliary positioning block is arranged between the two assembling columns.

10. The double-shaft hinge according to claim 9, wherein the body is not a flat straight piece.

11. The double-shaft hinge according to claim 1, wherein the first wheel comprises a first plane arranged at a face of the first wheel facing the shaft mounting base and connected with the first notch; and the second wheel comprises a second plane arranged at a face of the second wheel facing the shaft mounting base and connected with the second notch.

12. The double-shaft hinge according to claim 1, wherein the double-shaft hinge comprises a first torque generating component arranged on the first shaft and a second torque generating component arranged on the second shaft.

13. The double-shaft hinge according to claim 1, wherein the equal armed lever comprises a body formed with the first end and the second end, two assembling columns extending from the body and assembled with the two supporting blocks respectively, and an auxiliary positioning block formed on the body, and the auxiliary positioning block is arranged between the two assembling columns.

14. The double-shaft hinge according to claim 13, wherein the body is not a flat straight piece.
